(19) United States
(12) Patent Application Publication
(10) Pub. No.: US 2017/0103169 A1
(43) Pub. Date: Apr. 13, 2017

(54) Management Website and System to Optimize Development of the Most Beneficial of a Group of Diverse Technologies

(71) Applicant: Fannin Innovation Studio, Inc., Houston, TX (US)

(72) Inventors: Atul VARADHACHARY, Bellaire, TX (US); Leo LlNBECK, Houston, TX (US); Mark Worscheh, Houston, TX (US)

(21) Appl. No.: 15/051,249

(22) Filed: Feb. 23, 2016

Related U.S. Application Data
(60) Provisional application No. 62/240,829, filed on Oct. 13, 2015.

(51) Int. Cl. G06F 19/00; G06Q 50/22

(52) U.S. Cl. CPC G06F 19/327; G06Q 50/22

(57) ABSTRACT

A method of maximizing the benefits from a group of diverse healthcare technologies, by establishing a management entity which in turn establishes a website which sets forth its activities, were the activities involve in-licensing a diverse group of healthcare technologies; obtaining a funding pool to be allocated for development; forming a group of business units which is each responsible for developing at least one of the group of technologies, and where distribution to each business unit from the funding pool is determined by the management entity and each business unit reports its technology development progress, available and projected funding for development, and expenditures to the management entity; pooling the management entity and business unit personnel to manage development of the group of technologies; determining the likelihood of a business unit obtaining outside funding to develop technology; and distributing funding to a unit from the funding pool based on said likelihood.

### BACKGROUND

Developing opportunities in the health care field is constrained by the high cost and long period of development to regulatory approval, and the difficulty in predicting the likelihood of success in humans based on in vitro or animal model results; resulting in a high failure rate of individual projects. An often overlooked difficulty is in finding (on an affordable basis) experienced and successful development managers for health care projects. The complexity of product development through approval in this field requires experienced management, and such individuals are usually highly specialized in their management skill-set (i.e., they are specialists in particular clan of diagnostics or therapeutics). Many projects fail to obtain regulatory approval after years of development and expenditure of great wealth—often because of management errors from inexperience.

Because of the high failure rate early in development and unpredictability of success, a desirable development model would seek to maximize the number of opportunities to develop one or more marketable products, by developing as many as possible in parallel (like giving a team more shots on goal and thus more chances to score). Multiple diverse technologies are generally more difficult and more costly to manage than fewer, especially where the technologies are diverse: e.g., selected from one or more of the fields: diagnostics (including analytical devices and analysis of in vivo diagnostic markers), therapeutic devices, therapeutic methods and therapeutic products—which group includes molecular (DNA, RNA) products, protein products, and other new chemical entities. It is noted, however, that there can be similar steps and procedures needed for developing such diverse technologies, and thus, using those with generalized management experience who can in turn employ consultants on an as needed basis, may provide further cost advantages without sacrificing development speed or success.

To reduce failure rate, development progress must be critically examined by as experienced a_{[A1]} management team as affordable, and products unlikely to get to market must be de-funded or terminated as early as possible. A number of managers are required to make these calls with reasonable reliability, where there is a diverse group of technologies. The effective number of managers can also be cost-effectively expanded by retaining experts as consultants, as noted. In addition, the cost of a larger, diverse number of managers can be allocated across multiple projects, to thereby decrease the cost load on any particular one of the projects in development.

Ultimately, the ceiling on the number of managers is usually defined by weighing the benefits of a large team of experienced managers against the increased cost. A formula for pooling management or otherwise reducing costs for developing each project generally means more projects can be developed with a set funding pool.

The problem addressed herein is: where a group of technologies is in-licensed from a university or other invention-generating entity, how does one provide the greatest health benefit to the public (ensure the most health-significant technologies are commercialized) given a limited budget and a limited number of experienced development managers?

### SUMMARY

In the system of the invention, management is pooled by bringing together experienced people with a range of development or management skills across a range of fields, and where several such experienced people who serve on management also have specific responsibility for one or more of the projects in development, and individuals among such experienced people head up one or more constituent business units. The original inventor is preferably actively involved in the development—and may or may not be part of the management team. Because management experience is pooled, with each new project added and with each new manager added, the management entity's experience and expertise increases.

Administrative and related costs for individual projects are reduced by having a pooled management entity, instead of setting up separate management for each project. Administrative costs and other management costs not absorbed by the management entity (which is preferably done only on an interim basis) are allocated across the constituent projects_{[A2]} under development by the business units.

The pooled team preferably designates particular projects needed for development, for each business unit to undertake, with as much specificity as possible. The success of the business unit's performance of each project is evaluated by the management team. The team preferably reduces the cost of executing each such project by relying on grant funding as much as possible and by using lower cost graduate student and postdoctoral fellows (rather than experienced scientist/technologist) labor as much as possible.

Preferably, the management team relies on analysis of the present value (PV) of each business unit, and determines how much, if any, to invest in each project at each stage of development based on PV. The PV determination is based on a changing and re-determined discount rate, where discount rate determination includes determining the likelihood of the technology obtaining: (i) a development partner; and/or (ii) private or public or grant funding. The likelihood of obtaining a development partner or funding is driven by factors like market size (e.g. ultra orphan indications), size and cost of clinical studies required for approval, and regulatory status (e.g., whether it is a breakthrough designation, whether it qualifies for orphan or ultra orphan drug status, whether it is a generic or 510k equivalent, etc.).

This management system allows a much greater number of projects to be developed in parallel for the same investment: that would normally allow only far fewer to be developed. This system allows the multiple business units to each develop their respective technologies to a stage where the unit can independently raise money in public or private markets to continue development, or to where it can have a collaboration partner for further research or for full development to commercialization, and/or, where with or without additional funding support or a collaboration partner, the business unit can justify a dedicated development team.

The advantages and features of the management system herein are displayed on the management entity's website, in order to attract invention-generating entities to grant development rights to more technology they control to the management entity. As noted, adding more technology for development further increases the advantages of the management system and the management entity's chances of making individual technologies it controls (where it also owns or controls the business units) succeed.

### DETAILED DESCRIPTION

In the invention's system, the management entity controls a funding pool for partial funding of business entities. As the management entity has development experience and control of a pool of technologies, it has greater ability to access investor funding for particular projects than does any particular business entity under it. The management entity's continued success depends on it having a successful development track record, or else outside funding sources will tend to diminish. Its expertise increases with each added technology it develops through its business units. New technologies may be allocated to existing business units or new business units may be created for new technologies brought under development.

After technology selection by a business unit, the most immediate task is confirming its value through a rigorous examination of the science, and review of the status of peer-reviewed publications about the technology—including, planning for and providing additional publications, A vetting process (preferably by a pooled management team, see below) assesses the technology's commercial potential, legal hurdles and patentability, and its viability for attracting a development partner (including, preferably, an existing member of the health sciences industry).

As noted, the effective management team is expanded as much as reasonable, and at least by including some members from the business units on the team. The team can also include the technology inventors, as well as retained consultants, and scientifically trained trainers such as late-stage graduate students, postdoctoral fellows, medical students, residents and clinical fellows acting as interns. Use of trainee interns can provide an additional advantage, as it may facilitate collaboration between investigators in the business units and other technical experts (not employed or compensated) but who interact with the trainees in their respective institution laboratories and classrooms; e.g., faculty and other trainee colleagues.

The management style of the management team can vary widely, and allocation of the management team time to the various business unit projects is among the important initial decisions. It is preferred if the likelihood of advancing the technology is the primary factor considered in allocation of time and resources to particular business units and particular projects_{[A3]}. Concern with expenditures can be reduced if there is outside funding for a project, including grant funding. Outside funding can offset a longer or otherwise more expensive development cycle.

The management team routinely monitors each business unites technology development to determine the ongoing funding and resource allocations. All management team members review development cycles, planned experiments, experimental results, and seek out tests and experiments which both confirm and refute underlying hypotheses. Some projects may be terminated and staff re-assigned to other business units.

The management structure also encourages allowing the team to pause or discontinue development of particular projects more readily—because others are pending and perhaps more attractive. This pausing or discontinuing development can be exercised when there are scientific issues with a project, or if lengthy or expensive experiments needs to be conducted, or while waiting on grants or other inexpensive sources of funding.

Each business unit is directed to minimize cash expenditures which originate from the funds of the management entity—at least for the first few years of a project, or until another funding commitment is secured. This can be achieved with the structure herein, because administrative and personnel costs, including rent, are carried by the management entity (during the initial development, to the point of obtaining collaboration or outside funding). The structure also allows management to prioritize time of personnel to other projects where development slows in one; or where development demands increase for one or more such other projects. Management can also employ other outside expertise and resources where development demands such an increase.

As noted, the PV and discount rate determination is based on the likelihood of the technology obtaining: (i) a development partner; and/or (ii) private or public or grant funding. Availability of development partners and/or other external funding will be driven by a variety of factors that relate to the approvability and market size of the product, including: the potential indications; competitive technologies (both of commercialized products and also those in development); regulatory path to approval; formulary listing requirements; feasibility and complexity of the clinical trials required for approval; availability of pre-clinical models and their relative degree of correlation with clinical success; availability of surrogate markers or models that will allow evaluating risk more accurately with more limited initial human studies; previous failures or successes in the technology space; manufacturing challenges and complexity; supply chain issues (including product and precursor's shelf life and cold chain requirements); variable and fixed product costs and projected pricing limitations; patent life, patent breadth, and funding for patent enforceability; and, freedom to operate against third party patents, as well as against non-patent barriers (e.g., trade secrets, exclusivity periods for precursors and biologics, and distribution controls or export regulations).

Other factors in the discount rate determination can be specific to the particular product type. These other factors include: marketing issues, including difficulty in entering suitable major distribution channels with a new product; projected regulatory approval or formulary approval dates; and, changes in projected market size (it can change with in vitro test, animal model and clinical trial results). Changes in PV can also be evaluated in terms of whether the trend in either direction is accelerating over a time period. Such changes can result from conventional product development and marketing issues, and also from changes in regulatory guidance for approval of particular technologies (e.g., Orphan Drug designations; new categories of approved products, such as biosimilars or other generics; and approvals for other parties' new devices, which allow 510K filings for equivalent devices in development).

Management can therefore focus on PV in determining a technology's feasibility for further development. The PV determination should subsume nearly all important factors in making this decision.

Another path to funded development of a technology is through collaboration partnering. Partnering feasibility, and value of a partnership, is related to the number of potential partners in the space (which increases the likelihood of competitive bidding by more than one of them), and to the interest level in the technology generally; i.e., if it is a newly emerging or otherwise a high interest area. The likelihood of a partnership is also related to management and business unit relationships with the potential partners. The partners can be structured in a collaboration agreement with them to become part of the management team.

Likelihood of obtaining grant or grant-type funding that is non-dilutive or lightly-dilutive funding relates to governmental agency interest in the technology (NIH, NSF, DARPA, DOD, DOE, etc.), philanthropic or advocacy group interest (e.g. the cystic fibrosis foundation, AHA, Live Strong), and other foundations and groups with a particular interest in a therapeutic area, and including the interest of groups like the Gates Foundation supporting needed treatments or prophylactic measures in emerging markets.

Cost savings in development can also come from scientific collaborations, which may take place at several places in the development process. Achieving such collaborations can provide added benefits in the form of, again, effectively increasing the scientific and technical expertise of the management team. These collaborators will often have directly related knowledge and expertise which is then shared with the business units and the management team. The collaborators may be formally or informally members of the management team. Use of collaborators also allows increasing the effective development activities performed by the responsible business unit.

These scientific collaborations may be easier to achieve than expected, and result in a wide-ranging input of beneficial advice by the collaborators. The collaborators also may benefit because they may receive, from the responsible business unit, material for them to use in their ongoing experimental models that could contribute to scientific advances and publications by them. The collaborators also gain the ability to work with the business unit in applying for additional grant funding from sources available only to private companies, such as SBA loans. The collaborators may be part of the management team.

Another way to increase expertise and reduce personnel costs is to use interns or “apprentices” in the management entity and in the business units. These apprentices can include graduate students, medical students, postdoctoral fellows, residents, clinical fellows, and junior medical or university faculty. These apprentices would come and spend some of their time, without needing to give up their positions. It is advantageous for them in that they can obtain an up-close view of product development and entrepreneurship. The apprentices are therefore part of the management team.

Individual members of the management team can also head more than one of the business units at a time. Again, this spreads management expertise more efficiently.

In summary, the foregoing advantages and features of the management system herein are displayed on the management entity's website. This is to attract invention-generating entities to grant development rights to more technology they control to the management entity, and also to aid in obtaining collaboration partners and/or external funding or grants. Adding funding, collaboration or expertise further increases the advantages of the management system and the management entity's chances of making individual technologies it controls succeed.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention. The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method of maximizing the benefits from a group of diverse healthcare technologies, by establishing a management entity which in turn establishes a website which sets forth its activities, where the activities comprise:
in-licensing, by the management entity, a diverse group of healthcare technologies;
obtaining a funding pool to be allocated for development of said group;
forming a group of business units which is each responsible for developing at least one of the group of technologies, and where distribution to each business unit from the funding pool is determined by the management entity and each business unit reports its technology development progress, available and projected funding for development, and expenditures to the management entity;
pooling the management entity and business unit personnel to manage development of the group of technologies;
determining, by the pool, the likelihood of each business unit to obtain a collaborator or outside funding to develop its technology;
distributing funding to a unit from the funding pool and/or determining whether to actively assist each business unit in seeking collaboration or outside funding based on said likelihood;
assisting, by the pool, business units with approval and commercialization of their technology such that the technology is used to treat or diagnose patients; and
wherein the website discusses the pool's activities as a way of attracting additional technologies, funding and collaborators, to thereby enlarge the pool and increase the pool's expertise.

2. The method of claim 1 wherein early other funding for a business entity's technology is primarily from governmental grants or philanthropic organizations.

3. The method of claim 1 wherein the management entity owns the controlling interest in the business entity.

4. The method of claim 1 wherein a PV of each of the technologies is determined based on a changing and re-determined discount rate.

5. The method of claim 4 wherein discount rate determination includes determining the likelihood of technology obtaining regulatory approval and/or formulary listing.

6. The method of claim 4 wherein discount rate determination includes determining market size of the product.

7. The method of claim 6 wherein market size of the product includes determining: the potential indications; competitive technologies; regulatory path to approval; formulary listing requirements; feasibility and complexity of the clinical trials required for approval; availability of pre-clinical models and their relative degree of correlation with clinical success; availability of surrogate markers or models that will allow evaluating risk more accurately with more limited initial human studies; previous failures or successes in the technology space; manufacturing challenges and complexity; supply chain issues; and, fixed product variable and costs and projected pricing limitations.

8. A method of maximizing the benefits from a group of diverse healthcare technologies, by establishing a management entity which in turn establishes a website which sets forth its activities, where the activities comprise:
In-licensing, by the management entity, a diverse group of healthcare technologies;
obtaining a funding pool to be allocated for development of said group;
forming a group of business units which is each responsible for developing at least one of the group of technologies, and where distribution to each business unit from the funding pool is determined by the management entity and each business unit reports its technology development progress, available and projected funding for development, and expenditures to the management entity;
pooling the management entity and business unit personnel to manage development of the group of technologies;
determining, by the pool, the PV of the technology developed by each business unit, and based on comparison of the PVs among the different business units and/or comparison of changes in the PVs among the different business units, determining, by the pool, distribution of funding to each unit from the funding pool and/or determining whether to actively assist each business unit in seeking collaboration or outside funding;
assisting, by the pool, business units with approval and commercialization of their technology such that the technology is used to treat or diagnose patients; and
wherein the website discusses the pool's activities as a way of attracting additional technologies, funding and collaborators, to thereby enlarge the pool and increase the pool's expertise.

9. The method of claim 1 wherein early other funding for a business entity's technology is primarily from governmental grants or philanthropic organizations.

10. The method of claim 1 wherein the management entity owns the controlling interest in the business entity.

11. The method of claim 1 wherein PV is determined based on a changing and re-determined discount rate.

12. The method of claim 4 wherein discount rate determination includes determining the likelihood of technology obtaining regulatory approval and/or formulary listing.

13. The method of claim 4 wherein discount rate determination includes determining market size of the product.

14. The method of claim 6 wherein market size of the product includes determining: the potential indications; competitive technologies; regulatory path to approval; formulary listing requirements; feasibility and complexity of the clinical trials required for approval; availability of pre-clinical models and their relative degree of correlation with clinical success; availability of surrogate markers or models that will allow evaluating risk more accurately with more limited initial human studies; previous failures or successes in the technology space; manufacturing challenges and complexity; supply chain issues; and, fixed product variable and costs and projected pricing limitations.

15. A method of maximizing the benefits from a group of diverse healthcare technologies, by establishing a management entity which in turn establishes a website which sets forth its activities, where the activities comprise:
In-licensing, by the management entity, a diverse group of healthcare technologies;
obtaining a funding pool to be allocated for development of said group;
forming a group of business units which is each responsible for developing at least one of the group of technologies, and where distribution to each business unit from the funding pool is determined by the management entity and each business unit reports its technology development progress, available and projected funding for development, and expenditures to the management entity;
pooling the management entity and business unit personnel to manage development of the group of technologies;
determining, by the pool, the PV of the technology developed by each business unit, and based on comparison of the PVs among the different business units and/or comparison of changes in the PVs among the different business units, determining, by the pool, the likelihood of each business unit to obtain a collaborator or outside funding to develop its technology;
distributing funding to a unit from the funding pool and/or determining whether to actively assist each business unit in seeking collaboration or outside funding based on said likelihood;
assisting, by the pool, business units with approval and commercialization of their technology such that the technology is used to treat or diagnose patients; and
wherein the website discusses the pool's activities as a way of attracting additional technologies, funding and collaborators, to thereby enlarge the pool and increase the pool's expertise.

16. The method of claim 15 wherein the pool includes scientific collaborators, apprentices, interns, and consultants.

17. The method of claim 16 wherein the pool expands and contracts as determined by the management entity.

18. The method of claim 15 wherein the management entity provides information on technologies in development and their progress on the website.

19. The method of claim 1 wherein other funding for a business entity's technology is from governmental grants or philanthropic organizations.

20. The method of claim 1 wherein particular individuals among the personnel each act as heads of more than one business unit.
